(19) United States
(12) Patent Application Publication
(10) Pub. No.: US 2014/0297774 A1
(43) Pub. Date: Oct. 2, 2014

(54) SYSTEM FOR MANAGING CONFIGURATION UPDATES IN CLUSTER OF COMPUTATIONAL DEVICES

(71) Applicants: Bala Sridhar Munupalle, Hyderabad (IN); Srinivasa R. Addepalli, San Jose, CA (US); Vijaya Kumar Ambati, Hyderabad (IN); Atmaram Ganapuram, Hyderabad (IN)

(72) Inventors: Bala Sridhar Munupalle, Hyderabad (IN); Srinivasa R. Addepalli, San Jose, CA (US); Vijaya Kumar Ambati, Hyderabad (IN); Atmaram Ganapuram, Hyderabad (IN)

(21) Appl. No.: 13/853,061

(22) Filed: Mar. 29, 2013

(51) Int. Cl. H04L 12/24

(52) U.S. Cl. CPC H04L 41/04
USPC 709/208

(57) ABSTRACT

A system for managing configuration updates in a cluster of computational devices that includes a master device and a set of participant devices. The master device receives a first configuration command from a user, executes it and updates a configuration version number to a current configuration version number. Thereafter, the master device transmits a multicast message including the current configuration version number to the participant devices. A first participant device sends a configuration request to the master device for transmitting the first configuration command. Thereafter, the first participant device receives the first configuration command from the master device and updates its configuration version number to the current configuration version number.

### BACKGROUND OF THE INVENTION

The present invention relates generally to computational devices, and more particularly, to managing configuration updates in a cluster of computational devices.

A networked computing system includes various computational devices, such as routers, application delivery controllers and virtual private network (VPN) concentrators that are connected together to form a cluster and often have a common functionality and render a common set of services. Examples of services include unified threat management, deep packet inspection, firewall, intrusion detection and prevention, tunneling using internet protocol (IP) security for VPN, application level firewall, server load balancing and anti-virus and anti-spam security. Such a cluster improves performance and reliability of the computing system as the computational devices share the load required for executing the services.

For providing the same functionality, the computational devices are required to have same device configuration. Each computational device store a configuration file that includes a set of configuration commands that are executed thereat. A configuration command includes a set of instructions that are executed to modify the configuration of a service offered by the computational device. Each configuration command has a corresponding configuration version number. There exist many techniques for synchronizing configuration of all computational devices in a cluster. One such technique requires an administrator to manually update configuration each computational device in a cluster. The administrator copies the configuration file from the updated computational device to the other computational devices for execution. However the technique is time consuming and prone to errors as it requires manual copying of the configuration file on each computational device. Further, the configuration versions of the computational devices remain unsynchronized until the configuration file is copied to all the computational devices and results in erroneous functioning of the computational devices.

Another technique allows a computational device of the cluster to monitor other computational devices for an updated configuration version and upon identifying, the computational devices receive the configuration file from the computational device having the updated configuration version and execute the configuration file. Though the technique is automatic, the configuration versions of the computational devices in the cluster remain unsynchronized until all the computational devices search and detect the computational device having the updated configuration version.

Yet another technique uses an external element management system (EMS) that is added to the cluster and functions as a centralized system for synchronizing configuration across the computational devices. The EMS monitors the configuration versions of all the computational devices. When a configuration update is executed on a computational device, the EMS acquires the configuration update and executes it simultaneously on other computational devices. This mechanism ensures that configuration versions of all the computational devices are synchronized with each other. However, adding an external EMS increases cost and size of the computing system.

Therefore, it would be advantageous to have a system for managing configuration updates in a cluster of computational devices that eliminates manual intervention, that reduces time and cost, and that overcomes the above mentioned limitations of existing methods for managing configuration updates.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram illustrating a cluster of computational devices in accordance with an embodiment of the present invention;

FIG. 2 is a schematic block diagram illustrating master and participant devices of the cluster of FIG. 1, in accordance with an embodiment of the present invention;

FIG. 3 is a flow chart illustrating a method for managing configuration updates in a cluster of computational devices, in accordance with an embodiment of the present invention;

FIGS. 4A and 4B are flow charts illustrating a method for managing configuration updates in a cluster of computational devices, in accordance with an embodiment of the present invention;

FIGS. 5A and 5B are flow charts illustrating transmission and reception of configuration messages at a participant device, in accordance with an embodiment of the present invention; and

FIGS. 6A and 6B are flow charts illustrating transmission and reception of configuration messages at a master device, in accordance with an embodiment of the present invention.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a method for managing configuration updates in a cluster of computational devices is provided. The cluster includes a master device and a plurality of participant devices. A plurality of configuration commands including a first configuration command are received at a management engine of the master device. The first configuration command is shifted from the management engine to a command cache of the master device based on a command type of the first configuration command. The first configuration command is executed at the master device by a processor of the master device and a configuration version number of the master device is updated as a current configuration version number. The current configuration version number corresponds to the first configuration command. The first configuration command is moved from the command cache to a version history database of the master device. The version history database stores a mapping between the plurality of configuration commands and corresponding configuration version numbers. A configuration availability message is multicast to the plurality of participant devices. The configuration availability message corresponds to the first configuration command. A configuration request is received from a first participant device of the plurality of participant devices when a processor of the first participant device determines that a current configuration version number of the first participant device is less than the current configuration version number of the master device. The master device transmits the first configuration command to the first participant device for execution at the first participant device.

In another embodiment of the present invention, a system comprising a cluster of computational devices is provided. The cluster of computational devices includes a plurality of participant devices and a master device. The master device includes a management engine, a command cache, a version history database and a processor. The management engine receives a plurality of configuration commands including a first configuration command. The command cache stores the plurality of configuration commands based on command types of the plurality of configuration commands. The version history database stores a mapping between the plurality of configuration commands and corresponding configuration version numbers. The processor is connected to the management engine, the command cache, and the version history database. The processor shifts the first configuration command from the management engine to the command cache of the master device, based on a command type of the first configuration command and executes the first configuration command at the master device. Thereafter, the processor updates a configuration version number of the master device as a current configuration version number. The current configuration version number corresponds to the first configuration command. The processor further moves the first configuration command from the command cache to the version history database of the master device and multicasts a configuration availability message to the plurality of participant devices. The configuration availability message corresponds to the first configuration command. The processor receives a configuration request from a first participant device of the plurality of participant devices when a processor of the first participant device determines that a current configuration version number of the first participant device is less than the current configuration version number of the master device. The processor transmits the first configuration command to the first participant device for execution at the first participant device.

Various embodiments of the present invention provide a system and method for managing configuration updates in a cluster of computational devices. The cluster includes a master device and a plurality of participant devices. The master device receives and executes a first configuration command. The first configuration command corresponds to a current configuration version number of the master device. Thereafter, the master device transmits a multicast message conveying the availability of the first configuration command to the participant devices. Upon receiving a configuration request message from the participant devices, the master device transmits the first configuration command to the participant devices. The system of the present invention is completely automated and does not require an administrator to copy the configuration updates to the participant devices which reduces the time required for updating the configuration of the computational devices. As one of the computational devices (i.e., the master device) manages the transmission configuration updates to the other computational devices, an external configuration management system is not required which reduces the cost and size of the system. The system further ensures that all computational devices have the same configuration version and results in smooth functioning of the computational devices.

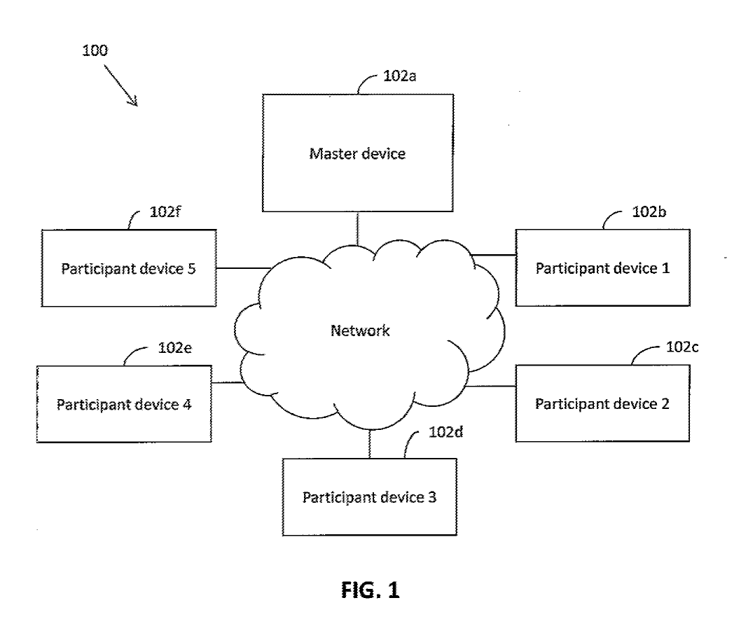

Referring now to FIG. 1, a schematic block diagram illustrating a cluster 100 of computational devices 102, in accordance with an embodiment of the present invention is shown. The cluster 100 includes first through sixth computational devices 102a-102f (hereinafter collectively referred to as computational devices 102). Examples of the computational devices 102a-102f include virtual private network (VPN) concentrators, application delivery controllers (ADCs) and networking devices, such as routers and switches. Each computational device 102 provides a specific service, examples of which include unified threat management, deep packet inspection, firewall, intrusion detection and prevention, tunneling using Internet Protocol Security for VPN, application level firewall, server load balancing and anti-virus and anti-spam functionalities.

The computational devices 102a-102f share the computational load for providing a service and have the same functionality, for which they are required to have the same configuration. In an example, the cluster 100 may provide services of a network firewall and a configuration update related to blocking incoming/outgoing data from a certain internet protocol (IP) address may need to be applied to each computational device 102. To facilitate the execution of the configuration update, a computational device 102 that first receives the configuration update is elected as a master device (the master device 102a) and the other computational devices are designated as participant devices (the participant devices 102b-102f). Thereafter, the master device 102a transmits the configuration update to the participant devices 102b-102f for execution.

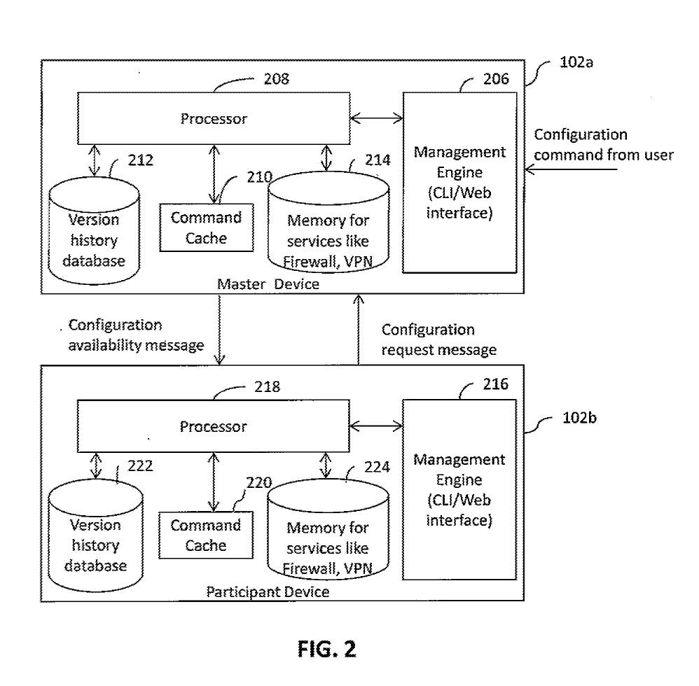

Referring now to FIG. 2, a detailed schematic block diagram illustrating the master device 102a and the participant device 102b, in accordance with an embodiment of the present invention, is shown. The master device 102a includes a management engine 206, a processor 208, a command cache 210, a version history database 212, and a memory 214. The processor 208 is communicatively coupled to the management engine 206, the command cache 210, the memory 214, and the version history database 212. The management engine 206 is configured to receive configuration commands from a user and may be implemented as a command line interface (CLI, not shown) or a graphical user interface (GUI) which can be a browser-based web application or a stand-alone client application.

Each configuration command has a command type that provides a description of the intended operation of the command. The processor 208 checks the configuration commands received at the management engine 206 and stores only those configuration commands that have a command type of: add/create, edit/modify/update/set and remove/delete. The add/create configuration command adds new configuration entries to the computational device 102 to implement a desired functionality of the service supported by the computational device 102, for example, addition of new firewall policy to the computational device 102. The edit/modify/update/set configuration command modifies existing configuration entries of the computational device 102, for example, modification of existing firewall policy on the computational device 102. The remove/delete configuration command removes existing configuration entries from the computational device 102 to apply the desired functionality of the service supported by the computational device 102, for example, deletion of an existing firewall policy from the computational device 102. The configuration commands are stored in the command cache 210. The memory 214 stores a configuration file that includes each configuration command that has been previously executed by the processor 208 and corresponding configuration version numbers. A configuration version number is a unique numeric identifier for each configuration command. The version history database 212 stores a mapping between the configuration commands and the corresponding configuration version numbers. In an embodiment of the present invention, each configuration command that has been previously executed by the processor 208 and its configuration version number are stored in a random access memory (RAM, not shown) of the master device 102a.

The participant device 102b also includes a management engine 216, a processor 218, a command cache 220, a version history database 222 and a memory 224, the functioning of which is similar to the management engine 206, the processor 208, the command cache 210, the version history database 212 and the memory 214, respectively of the master device 102a. The participant devices 102c-102f are similar to the participant device 102b.

The master and participant devices 102a and 102b each store a device information table (DIT) in the memories 214 and 224, respectively. The DIT stores an internet protocol (IP) address, a device state and a configuration version number of the computational devices 102. The device state contains information about whether a computational device 102 is a master or a participant device. The master device 102a has the device state field marked as “Master” and each of the participant devices 102b-102f have the device state field marked as “Participant”.

Table A below illustrates the entries of a DIT maintained by the master device 102a.

TABLE A
DIT Entries of master device

| | | Configuration version |
|---|---|---|
| IP Address | Device State | number |
| 11.28.44.55 | Master | 1.5.3 |
| 11.28.44.57 | Participant | 1.5.3 |
| 11.28.44.59 | Participant | 1.5.3 |
| 11.28.44.61 | Participant | 1.5.3 |
| 11.28.44.63 | Participant | 1.5.3 |
| 11.28.44.65 | Participant | 1.5.3 |

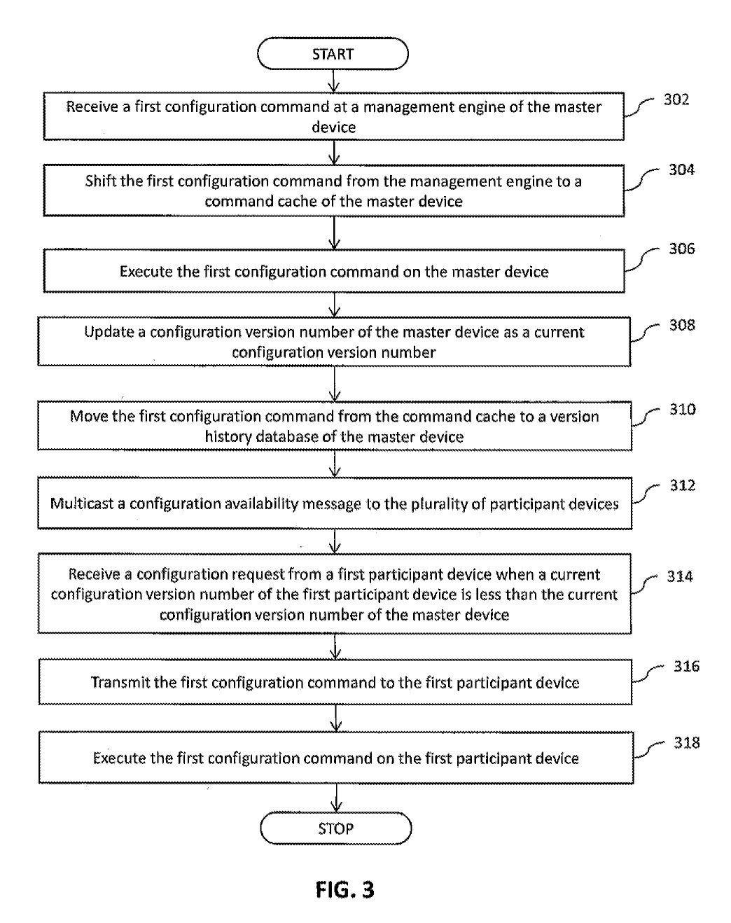

Referring now to FIG. 3, a flow chart illustrating a method for managing configuration updates in the cluster 100 of the computational devices 102, in accordance with an embodiment of the present invention, is shown. At step 302, the management engine 206 receives a configuration command. The configuration command has a command type of add, edit, or delete configuration. At step 304, the processor 208 shifts the configuration command from the management engine 206 to the command cache 210. At step 306, the processor 208 executes the configuration command. At step 308, the processor 208 updates a configuration version number of the master device 102a in the DIT of the master device 102a to a current configuration version number. The current configuration version number corresponds to the configuration command. At step 310, the processor 208 moves the configuration command from the command cache 210 to the version history database 212. The version history database 212 stores a mapping between the configuration command and the current configuration version number. At step 312, the processor 208 transmits a configuration availability message to the participant devices 102b-102f. The configuration availability message includes a device state and the current configuration version number of the master device 102a.

At step 314, the processor 218 receives the configuration availability message and checks whether configuration version number of the participant device 102b is less than the current configuration version number of the master device 102a. If the configuration version number of the participant device 102b is less than the current configuration version number of the master device 102a, i.e., if the participant device 102b is running an earlier configuration version than that of the master device 102a, the processor 218 transmits a configuration request message to the master device 102a. The configuration request message is a request from the participant device 102b to the master device 102a for transmitting the configuration command and the current configuration version number of the master device 102a to the participant device 102b. At step 316, the processor 208 receives the configuration request message from the participant device 102b and transmits the configuration command to the participant device 102b. At step 318, the processor 218 receives and executes the configuration command. The processor 218 updates the configuration version number of the participant device 102b to the current configuration version number of the master device 102a.

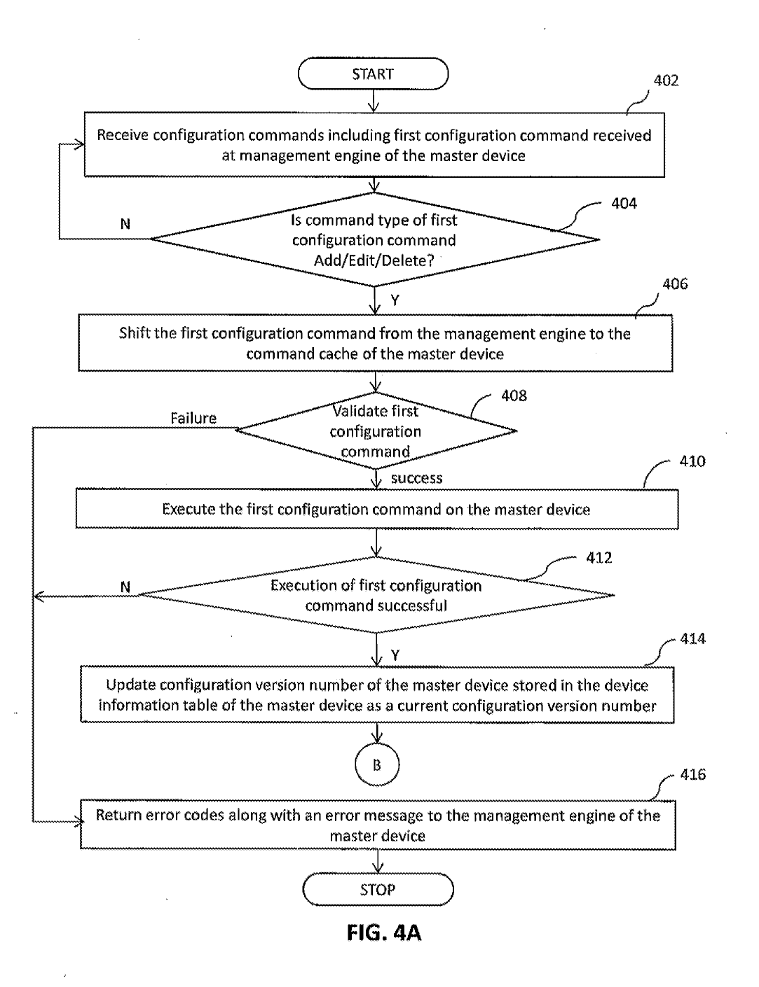

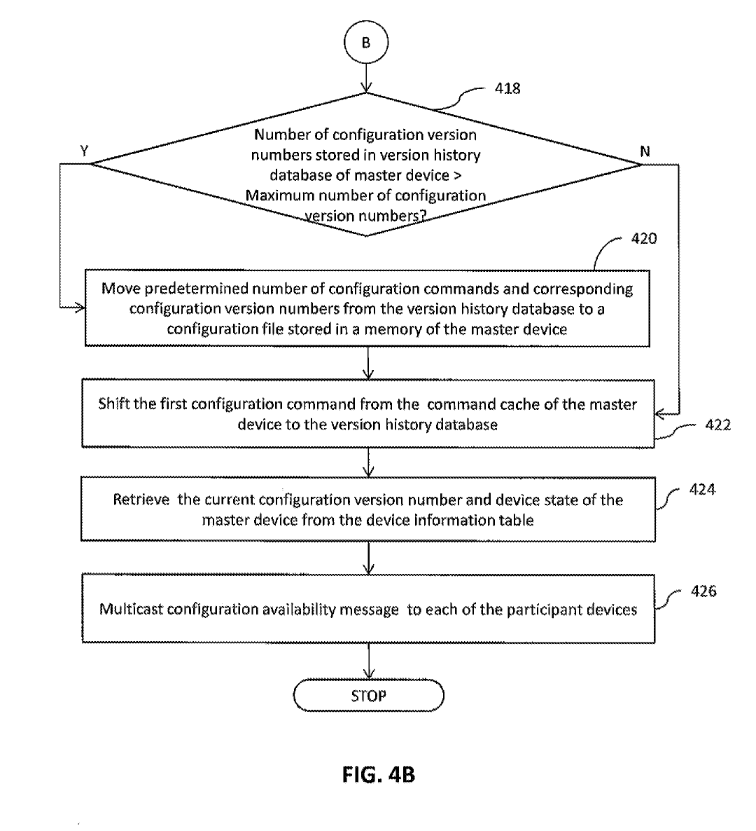

Referring now to FIGS. 4A and 4B, a detailed flowchart illustrating a method for managing configuration updates in the cluster 100 of the computational devices 102, in accordance with an embodiment of the present invention, is shown. At step 402, the management engine 206 receives the configuration command from the user. In an example, the configuration command may be ‘ADD Source IP Address: 11.00.98.6’ which is received from a user by way of the CLI or GUI. The command allows the master device 102a to receive data packets from a network device (not shown) having an IP address 11.00.98.6.

At step 404, the processor 208 checks whether the command type of the configuration command is add/create, edit/modify/update/set or delete/remove. If the command type of the configuration command is not add/create, edit/modify/update/set or delete/remove, the processor 208 discards the configuration command and the method returns to step 402. If the command type is one of add/create, edit/modify/update/set or delete/remove, the processor 208 moves the configuration command from the management engine 206 to the command cache 210, at step 406. In the current example, the processor 208 identifies the command type of the configuration command ‘ADD Source IP Address: 11.00.98.6’ as an add command and moves it to the command cache 210.

At step 408, the processor 208 validates the configuration command by checking parameters associated with the configuration command. If the validation of the configuration command fails, the method proceeds to step 416 at which the processor 208 returns an error code along with an error message to the management engine 206. If the configuration command is successfully validated at step 408, at step 410, the processor 208 executes the configuration command. In the current example, the processor 208 validates the configuration command ‘ADD Source IP Address: 11.00.98.6’ by checking if the IP address ‘11.00.98.6’ is within a valid standard range of IP addresses. If the validation is successful, the processor 208 executes the configuration command ‘ADD Source IP Address: 11.00.98.6’.

At step 412, the processor 208 checks if the execution of the configuration command was successful. If the execution of the configuration command is unsuccessful due to erroneous working of the master device 102a, step 416 is executed. If the execution is successful at step 412, at step 414, the processor 208 updates the configuration version number of the master device 102a stored in the DIT of the master device 102a to the current configuration version number. In the current example, upon successful execution of the configuration command ‘ADD Source IP Address: 11.00.98.6’, the processor 208 updates the configuration version number of the master device 102a stored in the DIT of the master device 102a from “1.5.3” to “1.5.4”, as shown in Table B below:

TABLE B
DIT Entries of the master device

| | | Configuration version |
|---|---|---|
| IP Address | Device State | number |
| 11.28.44.55 | Master | 1.5.4 |
| 11.28.44.57 | Participant | 1.5.3 |
| 11.28.44.59 | Participant | 1.5.3 |
| 11.28.44.61 | Participant | 1.5.3 |
| 11.28.44.63 | Participant | 1.5.3 |
| 11.28.44.65 | Participant | 1.5.3 |

Upon updating the configuration version number of the master device 102a, the processor 208, at step 418, checks whether a count of the configuration version numbers stored in the version history database 212 is greater than a maximum number of configuration version numbers that can be stored in the version history database 212. If the count is greater than the maximum number of configuration version numbers, at step 420, the processor 208 moves a predetermined number of configuration version numbers and corresponding configuration commands from the version history database 212 to the configuration file stored in the memory 214. In an embodiment of the present invention, the processor 208 moves half of the maximum number of configuration version numbers and corresponding configuration commands from the version history database 112 to the configuration file, based on a timestamp of each configuration version number. However, at step 418, if the count is not found to be greater than the maximum number of configuration version numbers, at step 422, the processor 208 shifts the configuration command ‘ADD Source IP Address: 11.00.98.6’ from the command cache 210 to the version history database 212.

At step 424, the processor 208 retrieves the current configuration version number and the device state of the master device 102a from the DIT of the master device 102a and generates the configuration availability message. An exemplary syntax of a message transferred between two or more computational devices 102 is shown in Table C below.

TABLE C
List of entries in a message transferred between
computational devices

| | | | | |
|---|---|---|---|---|
| [DEVICE | [DEVICE | [DEVICE STATE] | [CURRENT | [SAVED |
| IDENTIFIER] of | IDENTIFIER] | of the | CONFIGURATION | CONFIGURATION |
| the | of the | computational | VERSION | VERSION |
| computational | master | device 102 | NUMBER] of the | NUMBER] of the |
| device 102 | device 102a | transmitting | computational | computational |
| transmitting | | the message | device 102 | device 102 |
| the message | | | transmitting | transmitting |
| | | | the message | the message |

The saved configuration version number is a highest configuration version number in the configuration file of the computational device 102 that transmits the message. The entries of the configuration availability message are shown in Table D below:

TABLE D
configuration availability message entries

| | | | | |
|---|---|---|---|---|
| [DEVICE | [DEVICE | [DEVICE STATE] | [CURRENT | [SAVED |
| IDENTIFIER] of | IDENTIFIER] | of the master | CONFIGURATION | CONFIGURATION |
| the master | of the master | device 102a | VERSION | VERSION |
| device 102a | device 102a | | NUMBER] of the | NUMBER] of the |
| | | | master device | master device |
| | | | 102a | 102a |

In the example, the processor 208 retrieves the device state ‘Master’ and the current configuration version number ‘1.5.4’ from the DIT of the master device 102a for generating the configuration availability message, and at step 426, multicasts the configuration availability message to the participant devices 102b-102f.

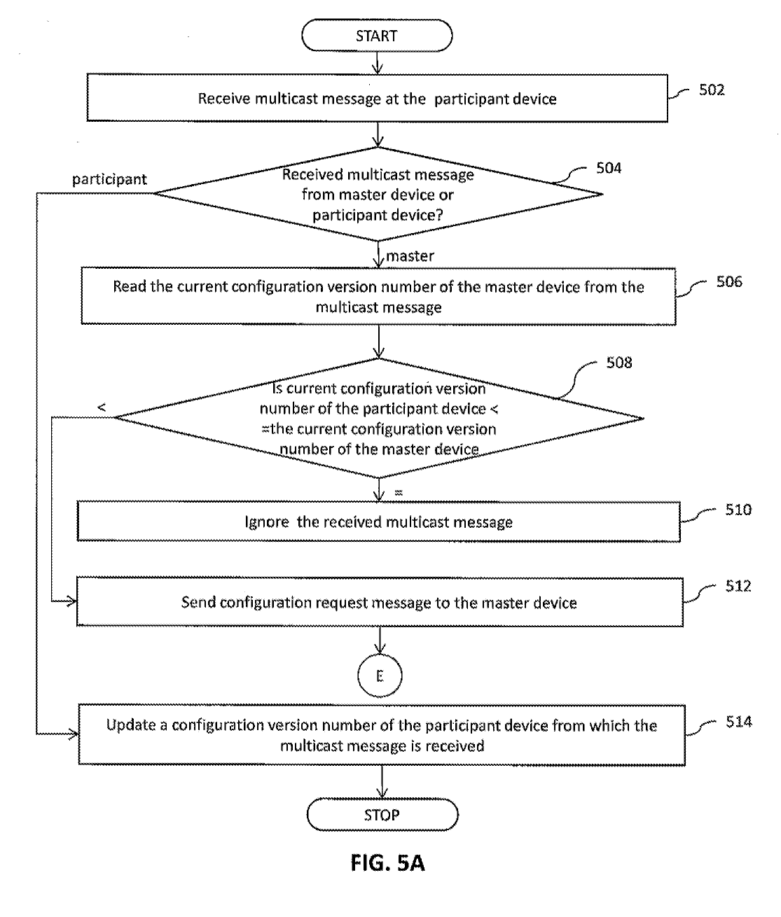

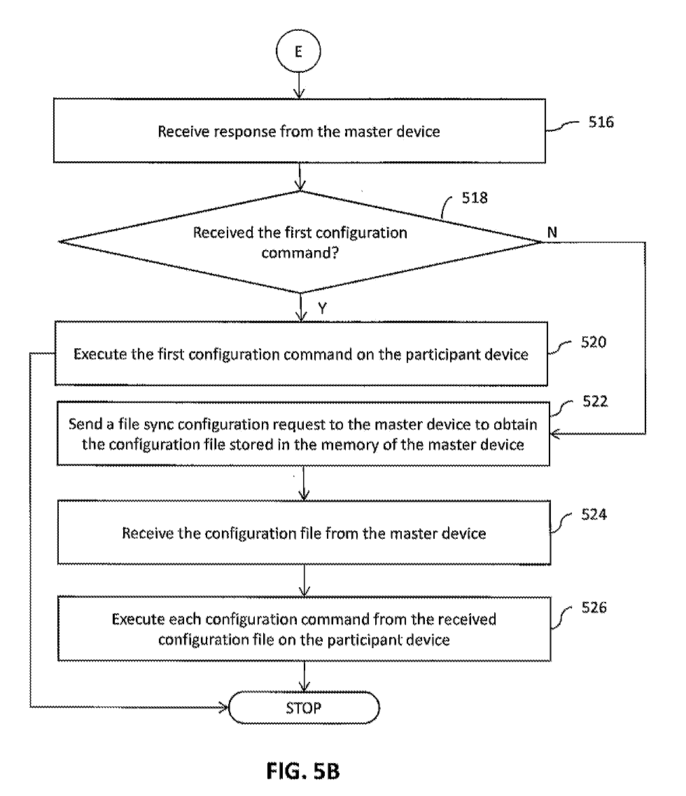

Referring now to FIGS. 5A and 5B, a flow chart illustrating transmission and reception of configuration messages at the participant device 102b, in accordance with an embodiment of the present invention, is shown. At step 502, the participant device 102b having an IP address ‘11.28.44.57’ receives a multicast message. At step 504, the processor 218 checks a device state in the received multicast message. If the device state is “participant”, at step 514, the processor 218 updates a configuration version number of the participant device that has sent the multicast message, in the DIT of the participant device 102b. At step 504, if the device state of the multicast message is “master”, the processor 218 identifies that the multicast message is a configuration availability message and step 506 is executed.

At step 506, the processor 218 reads the current configuration version number of the master device 102a from the configuration availability message and updates the configuration version number of the master device 102a stored in the DIT of the participant device 102b to the current configuration version number of the master device 102a. In the current example, the processor 218 assigns the configuration version number ‘1.5.4’ to the master device 102a in the DIT of the participant device 102b.

At step 508, the processor 218 checks if the configuration version number of the participant device 102b is less than or equal to the current configuration version number of the master device 102a, i.e., if the participant device 102b is running an earlier configuration version than that of the master device 102a. If the configuration version number of the participant device 102b is equal to the current configuration version number of the master device 102a, at step 510, the processor 218 ignores the configuration availability message. If the configuration version number of the participant device 102b is less than the current configuration version number of the master device 102a, at step 512, the processor 218 sends a configuration request message to the master device 102a requesting the master device 102a to transmit the configuration command. In the current example, the processor 218 receives the configuration availability message from the master device 102a and compares the configuration version number ‘1.5.4’ of the master device 102a and with the configuration version number ‘1.5.3’ of the participant device 102b, which is an earlier configuration version number. The processor 218 sends the configuration request message to the master device 102a for the configuration command ‘ADD Source IP Address: 11.00.98.6’. In an embodiment of the present invention, the processor 218 sends the configuration request message as a unicast message to the master device 102a.

At step 516, the processor 218 receives a unicast response from the master device 102a. At step 518, the processor 218 checks whether the unicast response received from the master device 102a includes the configuration command. If the unicast response includes the configuration command, at step 520, the processor 218 executes the configuration command and updates the configuration version number of the participant device 102b to the current configuration version number of the master device 102a, in the DIT of the participant device 102b.

In the current example, the processor 218 receives the configuration command ‘ADD Source IP Address: 11.00.98.6’ from the master device 102a, validates it and successfully executes the command and updates the configuration version number of the participant device 102b to ‘1.5.4’ in the DIT of the participant device 102b. Table C below illustrates the entries of the DIT of the participant device 102b.

TABLE E
DIT Entries of the participant devices

| | | Configuration version |
|---|---|---|
| IP Address | Device State | number |
| 11.28.44.55 | Master | 1.5.4 |
| 11.28.44.57 | Participant | 1.5.4 |
| 11.28.44.59 | Participant | 1.5.3 |
| 11.28.44.61 | Participant | 1.5.3 |
| 11.28.44.63 | Participant | 1.5.3 |
| 11.28.44.65 | Participant | 1.5.3 |

However, if the unicast response from the master device 102a includes an error message, at step 522, the processor 218 transmits a request to the master device 102a to transmit the configuration file stored in the memory 214. At step 524, the processor 218 receives the configuration file from the master device 102a. At step 526, the processor 218 validates and executes the entire configuration file (i.e., all configuration commands from the configuration file) and updates the configuration version number of the participant device 102b to the current configuration version number of the master device 102a. It will be apparent to those skilled in the art that the participant devices 102c-102f follow the same method as described herein for executing the configuration command.

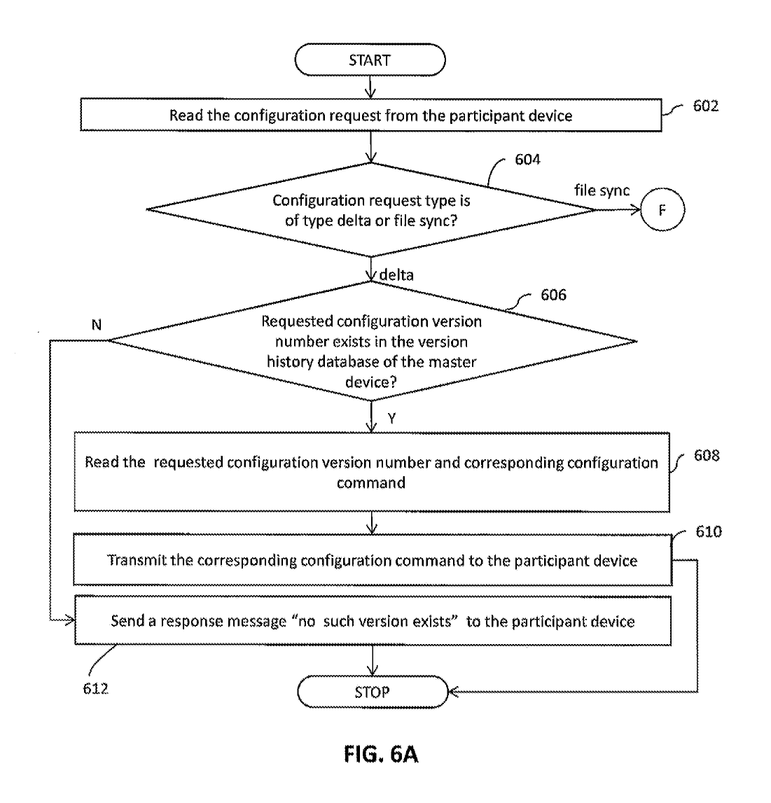

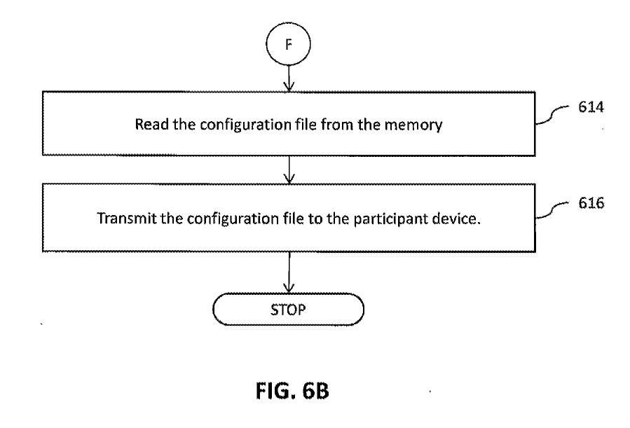

Referring now to FIGS. 6A and 6B, a detailed flowchart illustrating transmission and reception of configuration messages at the master device 102a, in accordance with an embodiment of the present invention, is shown. At step 602, the processor 208 receives the configuration request message from the participant device 102b. The configuration request message may be a delta request or a file sync request. A delta request prompts the master device 102a to transmit the configuration command and the corresponding current configuration version number to the participant device 102b. A file sync request prompts the master device 102a to transmit the configuration file stored in the memory 214 to the participant device 102b. The participant device 102b transmits the file sync request based on the saved configuration version number of the master device 102a in the configuration availability message. At step 604, the processor 208 checks the type of the configuration request message received from the participant device 102b. If the type is file sync request, at step 614, the processor 208 reads the configuration file from the memory 214, and at step 616, transmits the configuration file to the participant device 102b. The processor 218 receives and executes the configuration file and updates the configuration version number of the participant device 102b to the current configuration version number of the master device 102a, in the DIT of the participant device 102b.

At step 604, if the type of the configuration request is a delta request, at step 606, the processor 208 checks if the current configuration version number and the configuration command are available in the version history database 212. If the configuration command is available, at step 608, the processor 208 reads the configuration command and the current configuration version number from the version history database 212. If the configuration command and the current configuration version number are not available at step 606, at step 612, the processor 208 sends a response message to the participant device 102b indicating that the requested current configuration version number of the master device 102a is not available.

At step 610, the processor 208 transmits the configuration command and the current configuration version number to the participant device 102b. The processor 218 receives and executes the configuration command and updates the configuration version number of the participant device 102b to the current configuration version number of the master device 102a, in the DIT of the participant device 102b.

In an embodiment of the present invention, when a new participant device such as the participant device 102c joins the cluster 100 and sends a configuration request message of type file sync request to the master device 102a, the master device 102a transmits the configuration file stored in the memory 214 to the participant device 102c. The participant device 102c executes the configuration file and updates a configuration version number of the participant device 102c stored in a DIT of the participant device 102c to the current configuration version number of the master device 102a. In another embodiment of the present invention, if the current configuration version number of the participant device 102c is found to be less than the current configuration version number of the master device 102a (after executing the configuration file of the master device 102a), the participant device 102c transmits a delta request to the master device 102a.

In yet another embodiment of the present invention, the computational devices 102 transmit a multicast message including their configuration version number to each other. Thereafter, the computational device of the cluster 100 having the highest configuration version number is elected as the master device 102a.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for managing configuration updates in a cluster of computational devices, wherein the cluster includes a master device and a plurality of participant devices, the method comprising:
receiving a plurality of configuration commands including a first configuration command at a management engine of the master device;
shifting the first configuration command from the management engine to a command cache of the master device based on a command type of the first configuration command;
executing the first configuration command at the master device by a processor of the master device;
updating a configuration version number of the master device as a current configuration version number that corresponds to the first configuration command;
moving the first configuration command from the command cache to a version history database of the master device, wherein the version history database stores a mapping between the plurality of configuration commands and corresponding configuration version numbers;
multicasting a configuration availability message corresponding to the first configuration command to the plurality of participant devices;
receiving a configuration request from a first participant device of the plurality of participant devices when a processor of the first participant device determines that a current configuration version number of the first participant device is less than the current configuration version number of the master device; and
transmitting the first configuration command to the first participant device for execution thereby.

2. The method of claim 1, wherein the command type includes at least one of add, edit and delete configuration commands.

3. The method of claim 1, further comprising updating the current configuration version number of the first participant device to the current configuration version number of the master device.

4. The method of claim 1, wherein the first participant device ignores the configuration availability message when the current configuration version number of the first participant device is equal to the current configuration version number of the master device.

5. The method of claim 1, further comprising storing, at each computational device, a device information table (DIT) that includes a network address, a device state, and a current configuration version number corresponding to each of the plurality of computational devices.

6. The method of claim 5, wherein the configuration availability message includes the device state and the current configuration version number of the master device.

7. The method of claim 5, further comprising transmitting a multicast message by the first participant device to the plurality of participant devices, wherein the multicast message includes a device state and the current configuration version number of the first participant device.

8. The method of claim 1, further comprising transmitting each configuration command executed on the master device, to a configuration file stored in a memory of the master device.

9. The method of claim 8, further comprising transmitting the configuration file by the master device to a new participant device added to the cluster.

10. The method of claim 8, further comprising moving a predetermined number of configuration commands and corresponding configuration version numbers from the version history database to the configuration file when the number of configuration version numbers stored in the version history database is greater than a predetermined threshold number.

11. A system for managing configuration updates in a cluster of computational devices, comprising:
a cluster of computational devices, including:
a plurality of participant devices; and
a master device, wherein the master device includes:
a management engine that receives a plurality of configuration commands including a first configuration command;
a command cache that stores the plurality of configuration commands based on command types of the plurality of configuration commands;
a version history database that stores a mapping between the plurality of configuration commands and corresponding configuration version numbers; and
a processor, connected to the management engine, the command cache, and the version history database, for:
shifting the first configuration command from the management engine to the command cache of the master device, based on a command type of the first configuration command;
executing the first configuration command at the master device;
updating a configuration version number of the master device as a current configuration version number, wherein the current configuration version number corresponds to the first configuration command;
moving the first configuration command from the command cache to the version history database of the master device;
multicasting a configuration availability message corresponding to the first configuration command to the plurality of participant devices;
receiving a configuration request from a first participant device of the plurality of participant devices when a processor of the first participant device determines that a current configuration version number of the first participant device is less than the current configuration version number of the master device; and
transmitting the first configuration command to the first participant device for execution thereby.

12. The system of claim 11, wherein the command type includes at least one of add, edit and delete configuration commands.

13. The system of claim 11, wherein the first participant device updates the current configuration version number thereof to the current configuration version number of the master device.

14. The system of claim 11, wherein the first participant device ignores the configuration availability message when the current configuration version number of the first participant device is equal to the current configuration version number of the master device.

15. The system of claim 11, wherein each computational device further stores a device information table (DIT) that includes a network address, a device state, and a current configuration version number corresponding to each of the plurality of computational devices.

16. The system of claim 15, wherein the configuration availability message includes the device state and the current configuration version number of the master device.

17. The system of claim 15, wherein the first participant device transmits a multicast message to the plurality of participant devices, wherein the multicast message includes a device state and the current configuration version number of the first participant device.

18. The system of claim 11, wherein the master device further comprises a memory for storing a configuration file that includes each configuration command executed on the master device and corresponding configuration version numbers.

19. The system of claim 18, wherein the processor transmits the configuration file to a new participant device that is added to the cluster.

20. The system of claim 19, wherein the processor moves a predetermined number of configuration commands and corresponding configuration version numbers from the version history database to the configuration file, when a count of the configuration version numbers stored in the version history database is greater than a predetermined threshold number.
